(19) United States
(12) Patent Application Publication
(10) Pub. No.: US 2013/0239178 A1
(43) Pub. Date: Sep. 12, 2013

(54) SYSTEM AND METHOD FOR EXPANDING, AMALGAMATING, SELECTIVELY UTILIZING AND TRANSFORMING ACCESS TO NETWORKING WEBSITES AND USER INFORMATION THEREIN

(71) Applicant: Joseph J. LaRosa, Warren, NJ (US)

(72) Inventor: Joseph J. LaRosa, Warren, NJ (US)

(21) Appl. No.: 13/601,605

(22) Filed: Aug. 31, 2012

Related U.S. Application Data
(63) Continuation of application No. PCT/US11/27356, filed on Mar. 7, 2011.
(60) Provisional application No. 61/311,065, filed on Mar. 5, 2010.
(60) Provisional application No. 61/311,080, filed on Mar. 5, 2010.

(51) Int. Cl. H04L 29/06

(52) U.S. Cl. CPC H04L 63/10
USPC 726/4

(57) ABSTRACT

Systems and methods of expanding and enhancing the usefulness and accessibility of networking site and member user information therein are disclosed. An e-mailer, instant messenger, text messenger, blogger or other user with accounts at one or more sites (Sender) provides a recipient with access to the site or sites (or Sender's information therein) through a link, software tool, or the like. Alternatively, Recipients are given access to the networking site through an Aggregator site. The Aggregator site may or may not be part of the networking website. Control of access is determined by the Sender or networking site. An amalgamation or best of sites-social networking site can be utilized with embodiments of the disclosure. The amalgamation site is a filtered website that provides information put on other sites.

### CROSS-REFERENCE TO RELATED APPLICATIONS

This application is a continuation of and claims the benefit of priority to International Application No. PCT/US2011/027356, filed Mar. 7, 2011, which in turn claims the benefit of priority under 35 U.S.C. §119(e) to U.S. provisional application Ser. No. 61/311,080, filed on Mar. 5, 2010 and U.S. provisional application Ser. No. 61/311,065, filed on Mar. 5, 2010. The content of each of the aforementioned applications is incorporated herein in its entirety for any purpose whatsoever.

### FIELD OF THE DISCLOSURE

The disclosed embodiments relate generally to a system and method of expanding and transforming access to a website. More particularly, the disclosed embodiments relate to transforming access to a networking website and member user information therein for users who are not members of the networking website community. Furthermore, the disclosed embodiments relate generally to a system and method of filtering information from various websites and forming a website with the filtered information.

### BACKGROUND OF THE DISCLOSURE

Networking websites and blogs of today see more use than ever. Internet based sites such as Classmates, MySpace, Facebook, LinkedIn, Twitter, Match.com, The Huffington Post, Gawker, SmallWorld, Google Blog and the like are used in ever increasing frequency for social, employment, political, and cultural purposes and enjoyment. Even though such websites are growing in use, there remains a large population who either have not signed into these services to gain access, do not have the time or technical competence to do so or do not appreciate the importance and utility these sites have in the modern day to affect social, political, business and cultural change for themselves and others. Some web users are reluctant to provide the necessary information to gain access to these websites. The use of these networking websites often requires a user of the site to register and provide personal information about the user. Also some networking websites require users to take affirmative steps to search for other users to communicate with on the websites. This searching can become cumbersome and limits the usefulness of these networking websites since the common use of multiple user names makes it virtually impossible to use search functions to find the sites used by any particular individual.

Similarly, many of today's computer users have built extensive profiles on leading social internet websites. These social websites have their own methods of communication and notification. Communication between each of these social networks, or using information found on multiple social websites of a single user is often difficult. A mechanism that bridges these social networks and collects information for a user on these various websites does not exist. Networking websites and blogs of today see more use than ever.

Furthermore, the population segment that utilizes these networking websites cannot realize the full benefits of these sites because there is no tool that provides the user with the ability to offer others access to the user's site and information therein when a person is not signed up or refuses to sign up with the networking website. Additionally, there is no tool that provides a user of these websites access control to the user's sites or information when a person is not signed up or refuses to sign up with the networking website. Moreover, there is no tool that provides in one place comprehensive access at a user's option or anyone's option to access all of the user's networking sites and information therein whether or not the networking site has access restrictions or requirements and whether or not a third party invited by the user to view such sites and/or information has the necessary access to one or more of the user's networking sites.

Still further, the proliferation of networking sites for social, academic, employment, political, affinity and other reasons has created an enormous pool of data and information for each user. Users often join sites for various reasons and vary the type, quality and quantity of material uploaded to the site depending on the utility of that site to the user. Users build sites over time and often there is an array of information and material that may or may not support the user's vision for the site. For example, links to other sites or comments left by other users on the user's site, and the related links, may be useful for some purposes but not for wider distribution of for other uses. There is no clear way for a user to amalgamate portions of various sites into one site representing a “best of” compilation of a user's all or selected material for a targeted use or for all uses. Thus, there remains a need in the art to resolve these issues and needs.

### SUMMARY AND OBJECTS OF THE DISCLOSURE

The present disclosure provides for an apparatus and method of transforming non-access or restricted or limited access to one or more networking sites and a user's information therein into access when the party seeking access invited by the user is not a member or signed up for the networking site or sites. Embodiments of the disclosure facilitate and maximize the reach, usefulness and accessibility of these networking sites through various means such as email links, add-ons, pop ups, web software tools, conversion tools, and the like.

The present disclosure further provides for an apparatus and method for providing a user with a tool to pick and choose selected material from sites and upload them to a new site representing the view of the user that the user would like to present to third parties. Extraneous or irrelevant material that already exists on the user's sites would not be available to the viewer. This tool creates the additional benefit of allowing the user to selectively utilize portions of pre-existing sites. The Amalgamated website may be in one option a new website created by the individual user. The Amalgamated website in another option may be a pre-existing website that is utilized by several users. In addition, the Amalgamated website also maybe any combination of either option.

The terms “social website”, “networking site”, and “social networking site” are used interchangeably throughout the specification and are meant to cover all types of websites, bogs, and the like.

In one embodiment of the disclosure, an email user with accounts at one or more sites (Sender) provides an unlisted user (Recipient) with access to the Sender's sites and Sender's information therein through a link or other means that is automatically or manually generated (at Sender's option) upon the sending of an email, instant message, text message, blog post or comment or other such invitation to the Recipient by the Sender. The Sender has control of the access of the Recipient and can limit or individually tailor the use of the Sender's sites or information therein for each invitation sent to various Recipients. The Recipient of the invitation to join the Sender's sites or view the Sender's information therein can inform the Sender of an interest to accept the invitation. This notification is accomplished through an automatic or manually generated response message to the Sender (at Recipient's option) alerting the Sender that the Recipient would like to view the Sites. Upon receipt of that message, the Sender has options to accept the Recipients request for access, deny access, or limit access of the Recipient. Similarly, the host networking site may also impart such control.

In another embodiment, a new Website (Aggregator Site) is created that generates the necessary permission and access protocols for Recipients to access the Sender's individual website, the Sender's information therein, or entire networking website. In this embodiment, the Recipient will have access to the Sender's selected sites and information or networking sites without further login or acts on the Recipient's part. This “silent login” avoids the cumbersome login protocols and lengthy sign up procedures of current networking sites and avoids the difficulties associated with a Sender who uses multiple user names. The Aggregator Site will allow the Sender to select which sites, what aspects of these sites (including what of the Sender's information therein), and who of the Recipients may access them. Depending on the embodiment, a Recipient may also request selected access to a Sender's site. For the Sender to select sites, this embodiment is accomplished both for sites where the Recipient may already be a member or have access or is not a member and does not have access prior to the application of embodiments of this disclosure. In another embodiment, the Sender can create a “best of” or amalgamation of sites and information therein through the Aggregator Site which best suits the needs of the Sender in a particular case. The individual selectivity provided by each of these embodiments is useful in many areas such as job searches, business networking and social and political activities. Depending on the embodiment, the Sender or the Recipient may be members of some networking sites but not necessarily members of all the sites, and still be able to utilize the Aggregator site.

One of the benefits of this aggregator site is that it can assemble a myriad of other websites, blog listings, and other internet based information that defines the Sender's Profile. All this information is available in one site and is beneficial to the Sender whether or not the Recipient is a member of the site.

An additional object of the present disclosure is the use of the networking sites themselves generating messages either through an auxiliary Aggregator Site or through software tools and the like described herein. In this embodiment, the networking site generates the invitation messages or provides aggregator features of this disclosure. Further, the email or web site hosts of the networking websites, or unaffiliated hosts of emails, instant messages, bogs or text messaging (such as AOL mail, AIM, Gmail and Yahoo Mail) may offer the aggregator feature of the automatic email features and other features of this disclosure to its users. This access may be through a full member of the networking website or unaffiliated host, or through users that have not signed up with the particular networking website or unaffiliated host.

In another embodiment of this aspect of the present disclosure, an email user with accounts at one or more sites (Sender) provides an unlisted user (Recipient) with access to the Sender's sites and Sender's information therein through a link or other means that is automatically or manually generated (at Sender's option) upon the sending of an email, instant message, text message, blog post or comment or other such invitation to the Recipient by the Sender. The Sender has control of the access of the Recipient and can limit or individually tailor the use of the Sender's sites or information therein for each invitation sent to various Recipients. The Recipient of the invitation to join the Sender's sites or view the Sender's information therein can inform the Sender of an interest to accept the invitation. This notification is accomplished through an automatic or manually generated response message to the Sender (at Recipient's option) alerting the Sender that the Recipient would like to view the Sites. Upon receipt of that message, the Sender has options to accept the Recipients request for access, deny access, or limit access of the Recipient. Similarly, the host networking site may also impart such control.

In a still further embodiment of this aspect, the Sender can create, although may also pre-exist as a website, a “best of” or amalgamation of sites and information therein which best suits the needs of the Sender in a particular case. The individual selectivity provided is useful in many areas such as job searches, business networking and social and political activities. Depending on the embodiment, the Sender or the Recipient may be members of some networking sites but not necessarily members of all the sites, and still be able to utilize the “best of” Amalgamation website.

One of the benefits of this Amalgamation site is that it can assemble a myriad of other websites, blog listings, and other internet based information that defines the Sender's Profile. All this information is available in one site and is beneficial to the Sender whether or not the Recipient is a member of the site.

The foregoing objects are achieved and other features and advantages of the present disclosure will become more apparent in light of the following detailed description of exemplary embodiments thereof, as illustrated in the accompanying drawings.

### BRIEF DESCRIPTION OF THE DRAWINGS

In the drawings, wherein similar reference characters denote similar elements throughout the several views:

FIG. 1 shows a schematic flow diagram of one embodiment of a method and system for generating access to networking sites.

FIG. 2 shows a schematic flow diagram of another embodiment of a method and system for generating access to networking sites and Sender's information therein by using an Aggregator Site.

FIG. 3 shows a schematic flow diagram where features of the Aggregator Site are with the host networking site and invitations to join or view Sender's information therein are through a Sender or current member of the networking site.

FIG. 4 shows a schematic flow diagram where features of the Aggregator Site are with the host networking site and invitations to join or view Sender's information therein are directly from the networking site instead of a Sender.

FIG. 5 depicts a schematic block diagram depicting one embodiment of the system and method as shown in FIG. 1.

FIG. 6 depicts a schematic block diagram depicting one embodiment of the system and method in FIG. 2 of the present disclosure using an Aggregator Site.

FIG. 7 shows a schematic flow diagram of the embodiment of the system and method in FIG. 3 where the Aggregator Site is at the host networking site.

FIG. 8 shows a schematic flow diagram of the embodiment of the system and method in FIG. 4 where the Aggregator Site is at the host networking site and invitations to join the networking site or view Sender's information therein are sent to directly by the host networking site.

FIG. 9 shows a schematic flow diagram of a further embodiment of a method and system for utilizing an amalgamated website containing selected information from other web sites, bogs and the like.

FIG. 10 shows a schematic block diagram depicting the further embodiment of the system and method as shown in FIG. 9.

FIG. 11 shows a schematic flow diagram of the further embodiment of a method and system for utilizing an amalgamated website containing selected information from other web sites, bogs and the like.

FIG. 12 shows a schematic block diagram depicting the further embodiment of the system and method as shown in FIG. 11.

### DETAILED DESCRIPTION

Embodiments of the present disclosure will now be described in detail with reference to the accompanying drawings. The present disclosure relates to a computerized method and system for transforming access to a host networking site or information contained therein to non-members (or others with restricted or limited access) of the host site or “Recipients.” One typical example of an embodiment of this disclosure is where members of the networking sites or “Senders” send, for example, a message such as but not limited to an email asking the Recipient to join the Sender's personalized site or the host networking site or to view the Sender's information therein. Access is obtainable either through a software tool, link, pop-up, or the like that may be delivered by an email or other means. Alternatively, an Aggregator Site may be used allowing Senders and Recipients flexibility to control and get access to various networking sites (and the Sender's information therein) with various access protocols which may or not be met by a particular Recipient. The Aggregator Site may be a stand alone website or feature may be embedded in the host networking site or an affiliated or unaffiliated host of emails, instant messaging, text messaging, blogging and the like, depending on the embodiment.

Similarly, the present disclosure relates to a computerized method and system for filtering information from selected websites and downloading to a single website or generating a website with the filtered information. In one embodiment of the disclosure, members of networking sites or “Senders” send for example, a message such as but not limited to an email asking a “Recipient,” which may or may not be a member of the websites, to join the Sender's personalized site or a hosting networking site or to view the Sender's information that has been filtered from other sites. This site would allow a Sender to pick and choose from his or her various networking sites, and put in one place the “best of” information from those sites. Personalization of the “Amalgamated Website” that contains filtered information from other websites may be done. In this embodiment, access is obtainable either through a software tool, link, pop-up, or the like that may be delivered by an email or other means.

In another embodiment the user selects material from one or more sites and links that material to the Amalgamated Site. Depending on the rules of the site, the material will either be uploaded to the new Amalgamated Site or the material will become available through a link to the site or other mechanism. The user can do this with as many sites as he or she wishes, with the resulting uploads to the Amalgamated Site allowing the user to create an overall “best of” site or one or more sub-sites within the Amalgamated Site for designated purposes (e.g., employment, social, group specific (such as political, dating, affinity or clubs), tasks or creation of personal networks of individuals.

In still yet in another embodiment, through the use of the Amalgamated Site the user creates a “site of sites” which becomes the top-level site for the user to reference to others. This creates a single source access point for the user and viewers of the user's sites or information.

At the option of the user from time to time, when the user uploads information or links information to an existing site, all or part of that information as determined by the user is simultaneously uploaded to the Amalgamated Site. This enables the user to save time and populate the Amalgamated Site (or the relevant sub-site) with information relevant to the user or the particular use of the Amalgamated Site or sub-site. This can occur automatically through a link or other mechanism to the Amalgamated Site or manually.

It is within the scope of the disclosure for the Amalgamated Site to be an independent Web site joined by the users. In another embodiment, the Amalgamated Site can be a Web site affiliated with one or more of the existing sites. In addition, the Amalgamated Site can be a Web site affiliated with or supported by the existing sites in combination with an independent Web site.

Referring to the drawings, one sees that FIG. 1 illustrates one embodiment of the present disclosure. Networking site 103 may be any type of site for example on the internet that requires access through members-only passwords or questionnaires. Sender 101 is a member of the networking site and depending on the embodiment is an email user, text messenger, instant messenger, blogger, etc. (whose email, text, etc. is hosted by the networking site or by an unaffiliated host) with accounts at one or more sites such as 103. A Recipient 102 is one that receives an invitation from the Sender 101 to gain access to the networking site or the Sender's personalized site or Sender's information therein. Communication links join the networking site and Sender. The Recipients have access to the site or such information through the Sender, however it is within the scope of this disclosure that the networking site or an affiliated or unaffiliated email, text, blog, etc. The host may send invitations for access directly to the Recipients 102 (see FIG. 4) to join the networking site and Sender. Communication links are preferably data links. Such data link can alternatively be, but is not limited to, an electronic data link, optical fiber connection, wireless data connection or any other known connection used for data transfer, for example, over the internet as an email, text message, instant message or the like, including any other communication. Depending upon the implementation, communication link can operate in one or more modes of transmission. For example, such modes include radio frequency transmissions, optical transmission, microwave transmission, digital or analog transmission, or other known data transmission.

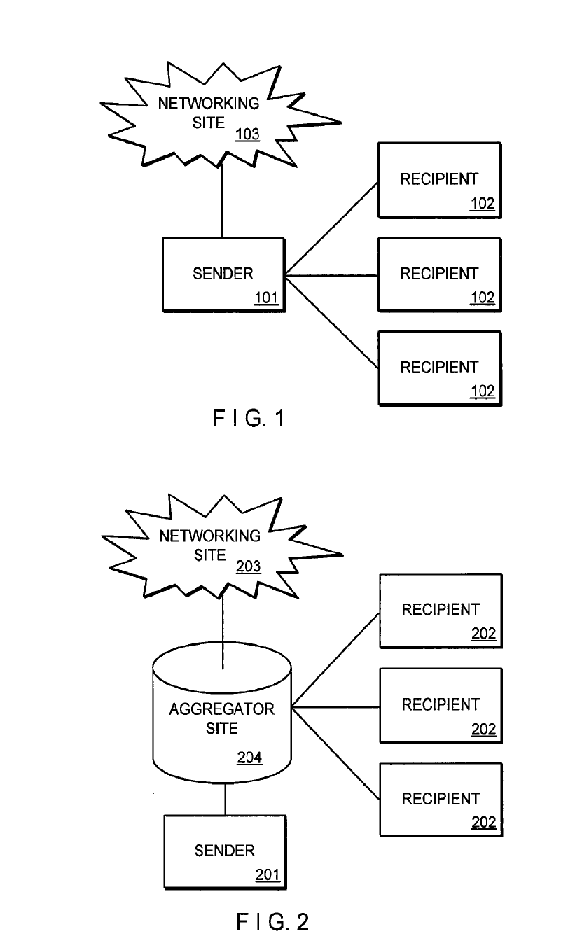

FIG. 2 includes an Aggregator Site 204. The networking site, Recipient, and Senders in FIG. 2 are related to the same in FIG. 1. The Aggregator Site allows the Sender to select what sites and aspects and who may access the Sender's sites and Sender's information therein. The Aggregator Site may include a server. The Server depicts a network, mainframe computer, processor, in communication with or including an image storage/retrieval system, or a database of content as described herein. The Server, when specifically operating in accordance with the principles of the disclosure operates as a receiver, translator, processor, filter, storage, and distributor of content related data. The server receives content from the content provider and responds to requests from a subscriber website. Additional features include without limitation a display of a user's social networking activity and that of the user's contacts; ability to search several social networks with a single search inquiry, typically configured as a “form”; ability of users to track what their friends/family/contacts are doing on various social networks (which may be envisioned as an RSS feeder for social networks); auto-integration from a user's address book and contact list; and ability to monitor sites for mention of the user's name (or any other similar string). All data entry between the computer and the user can be done by conventional methods, such as a mouse, a trackball, or any kind of pointer, and may be incorporated with such configurations as “drag and drop”.

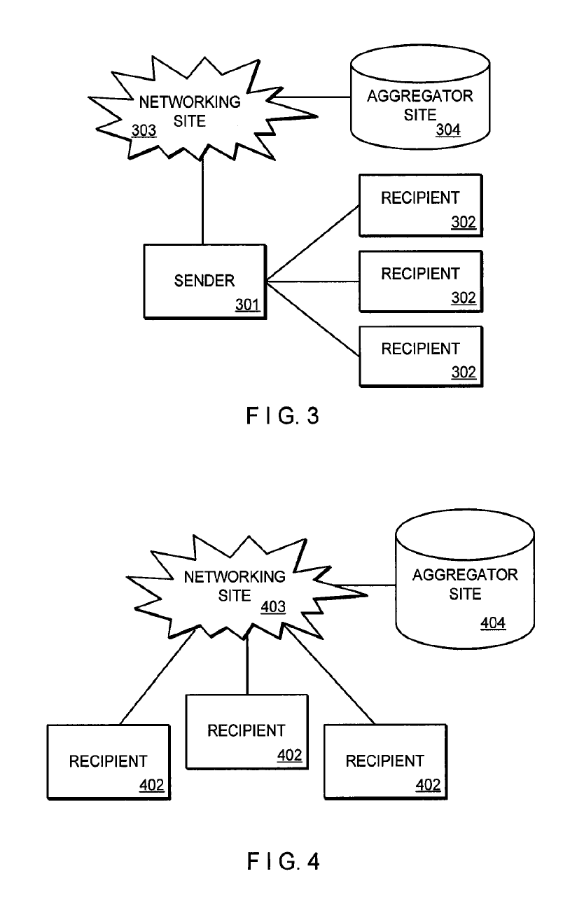

FIG. 3 illustrates the Aggregate Site 304 in direct communication with the networking site but not in direct communication with the Sender or the Recipient. The Sender in this embodiment has direct communication to the Recipients. Again, the networking site, Sender and Recipients are related to the same in FIG. 1.

FIG. 4 illustrates direct contact between the networking site and Recipient. The Aggregator Site may be independent such as an off-site server, or its features may be incorporated into the networking site or into features offered by an affiliated or unaffiliated email, text message, instant message, blog, etc. host.

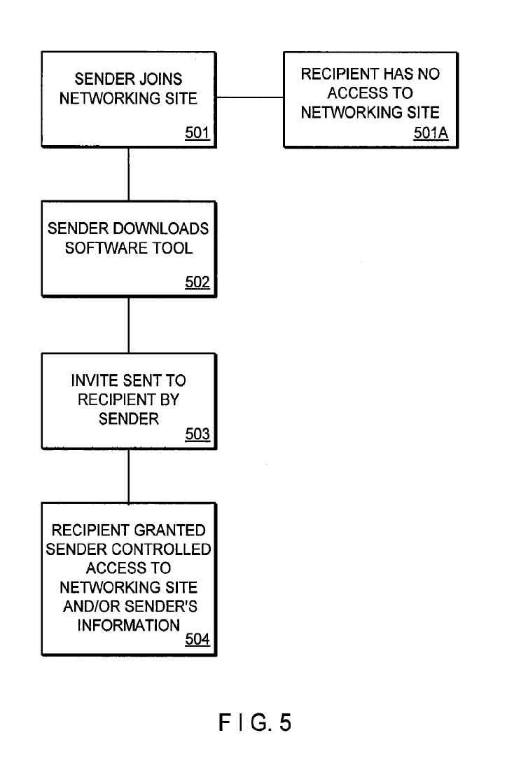

FIG. 5 illustrates a sender joining a networking site 501. A Recipient has no, limited or restricted access to the networking site as shown in block 501A. The Sender may download a software tool or receive by other means the necessary software or link to give access to the site or to Sender's information therein by the Recipient. An invitation is sent by the Sender as shown in block 503. The Recipient is then granted access with Sender, or Network control of the access. Network or its control includes but is not limited to an internet service provider or host networking site and the ability of that entity to control access.

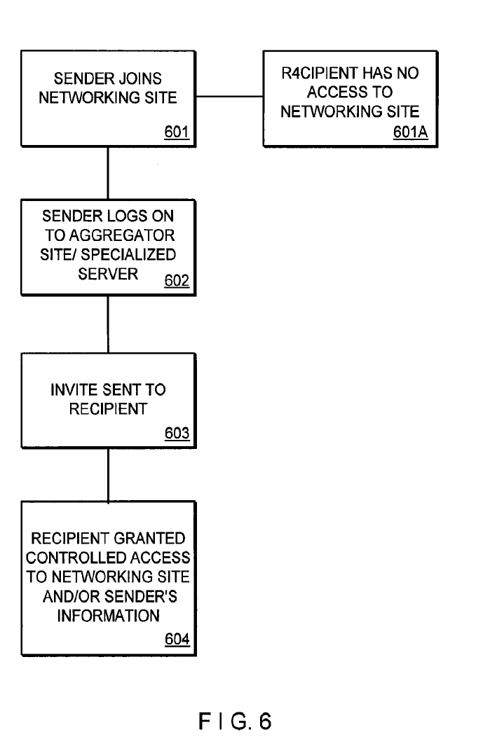

In another embodiment as shown in FIG. 6, the Recipients do not have access to the networking site. The Sender logs on to the Aggregator Site as shown in block 602. A Recipient is sent an invitation as shown in block 603, and granted access as illustrated by block 604. Depending on the implementation, the login to the aggregator site may be an automatic feature of the email or text mail for example.

In another embodiment, login to the aggregator site is an automatic feature of the email, text, and the like. This embodiment would allow Networking sites such as, but not limited to, Facebook, MySpace, LinkedIn, and the like to use the Aggregator site as a part of their hosting site. In addition, it is within the scope of this disclosure to allow the use of the Aggregator site to email providers such as AOL, Gmail and the like.

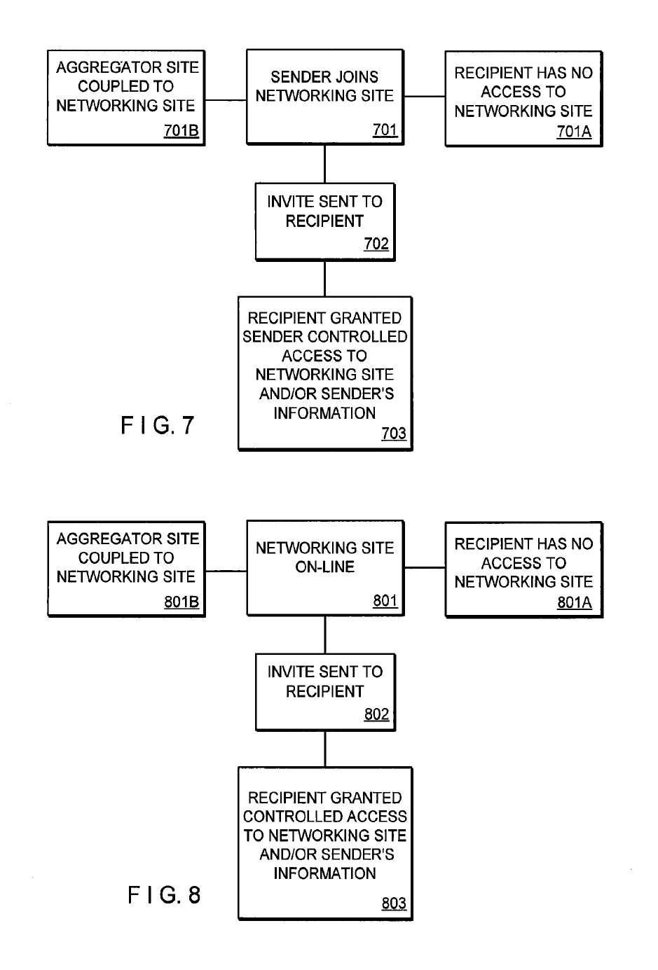

FIG. 7 illustrates a method using an Aggregator Site that is directly tied in either by features or by physical connections to the networking site. The Aggregator Site features can also be incorporated as a feature offered by the affiliated or unaffiliated email, text message, instant message, blog, etc. host. Again the Recipient does not have access to the networking site 701A. The Sender may send out an invitation to the Recipient to join or to view the Sender's information therein, and access granted as shown as 702 and 703.

FIG. 8 shows one embodiment how the networking site may contact the Recipient directly. Again, the Recipient has no access to the site as shown in 801A. An Aggregator Site is either offsite or its features incorporated in the networking site or its features are incorporated into the features offered by the affiliated or unaffiliated email, text message, instant message, blog, etc. host. The networking site may send the Requestor directly as shown in block 802. Access is granted as shown in block 803 and may be controlled by the networking site directly for this application.

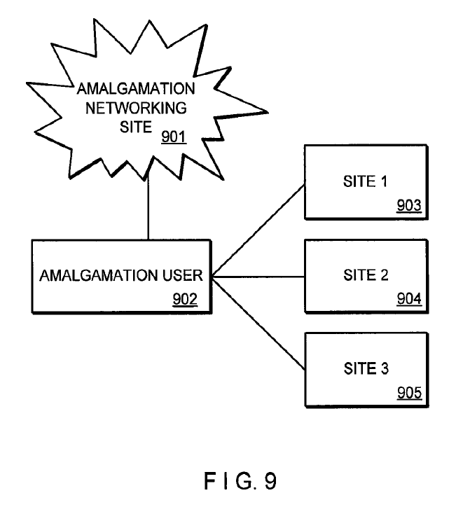

FIG. 9 illustrates a further embodiment of the disclosure. Networking sites 903, 904, 905 may be any type of site, blog or the like, for example on the internet that requires access through member only passwords or questionnaires. User or Sender 902 is a member of multiple networking sites and depending on the embodiment is an email user, text messenger, instant messenger, blogger, etc. (whose email, text, etc. is hosted by the networking site or by an unaffiliated host) with accounts at one or more sites such as 903, 904 and 905. In FIG. 9, an Amalgamated website 901 is user generated. This website may also be pre-existing and available to many users, individually generated, user accessible only with invitation rights, or any combination thereof.

In one embodiment where the Amalgamated website 901 is accessible by invitation, a Recipient (not shown in FIG. 9) is one that receives an invitation from the Sender 902 to gain access to the Amalgamated site or the Sender's personalized site or Sender's information therein. Communication links join the networking site and Sender. The Recipients have access to the site or such information through the Sender, however it is within the scope of this disclosure that the networking site or an affiliated or unaffiliated email, text, blog, etc. The host may send invitations for access directly to the Recipients to join the networking site and Sender. In addition, invitations can be sent through the Amalgamated site. Communication links are preferably data links. Such data link can alternatively be, but is not limited to, an electronic data link, optical fiber connection, wireless data connection or any other known connection used for data transfer, for example, over the internet as an email, text message, instant message or the like, including any other communication. Depending upon the implementation, communication link can operate in one or more modes of transmission. For example, such modes include radio frequency transmissions, optical transmission, microwave transmission, digital or analog transmission, or other known data transmission.

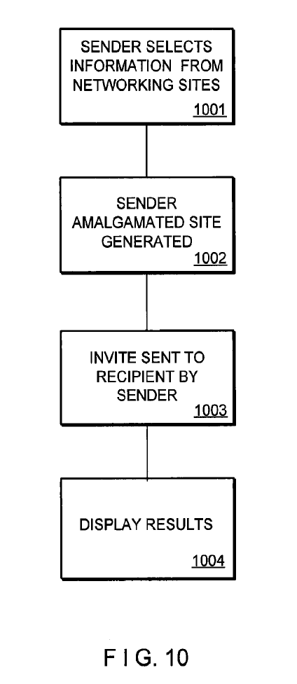

FIG. 10 illustrates a further embodiment of the method used in the present disclosure. A Sender selects information from selected networking websites that the Sender has utilized as shown in block 1001. The information is either downloaded, linked or other known means transmitted to a Sender generated Amalgamated website as shown in block 1002. Again the Amalgamated website may be a pre-existing website, user (sender) generated website, or any combination thereof. The Amalgamated website may include a server. The Server depicts a network, mainframe computer, processor, in communication with or including an image storage/retrieval system, or a database of content as described herein. The Server, when specifically operating in accordance with the principles of the disclosure operates as a receiver, translator, processor, filter, storage, and distributor of content related data. The server receives content from the content provider and responds to requests. The Amalgamated website may be independent such as an off site server, or its features may be incorporated into the networking site or into features offered by an affiliated or unaffiliated email, text message, instant message, blog, etc. host. The Sender can send invitations to Recipients to view the Amalgamated website as shown in block 1003. The information is then displayed to the Recipient and/or Sender as shown in block 1004.

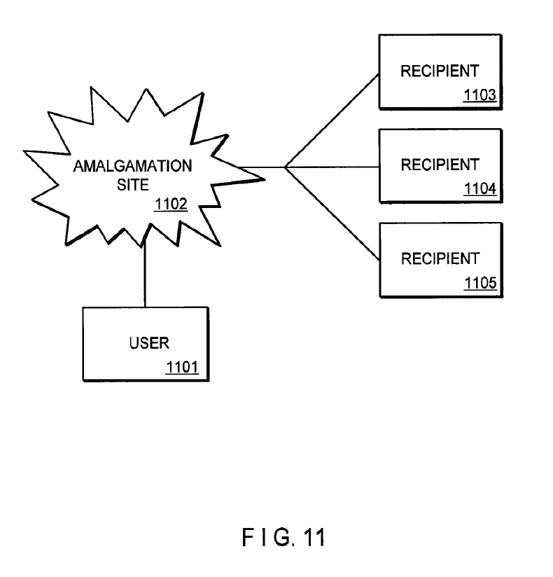

FIG. 11 illustrates a pre-existing Amalgamated website that may be utilized by one or more Senders (Users). The Senders are in direct communication with the Amalgamated website. The User 1101 utilized the Amalgamated website 1102 to filter information from networking sites 1103, 1104, 1105. The information may or may not be the sender's information. It is within the scope of this disclosure that the sender can utilize the Amalgamated website to generate a single website from his or hers own information, one or more other users' information, and any combination thereof.

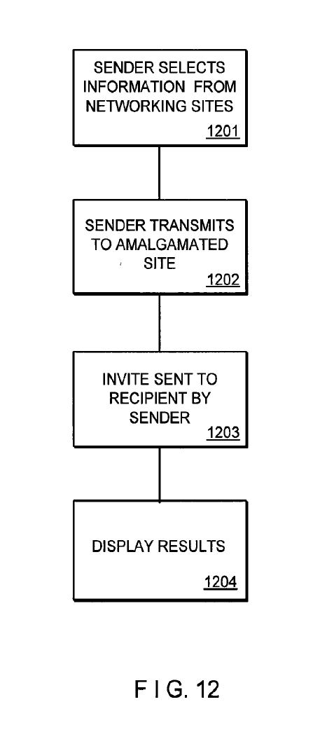

FIG. 12 illustrates exemplary process steps for the embodiment in FIG. 11. A Sender selects what networking sites he or she wants to filter as shown in block 1201. The filtered information is downloaded, linked or transmitted by other known means to an Amalgamated site 1202. The Sender can invite a Requester 1203 to view or gain access to the filtered information in the amalgamated site 1202. The results or information may then be displayed to the Requester and/or Sender.

Other alternative embodiments or implementations according to the various teachings of the present disclosure will be understood by those skilled in the art and are achieved without departing from the spirit and scope of the disclosure. In accordance with the scope of the disclosure, access to the networking site or other sites may include exclusive access to the site or sender's information, or combination of both access to the site and sender's information. It is therefore intended that the present disclosure is not limited to the disclosed embodiments described herein but should be defined in accordance with the claims that follow.

I claim:

1. A system for generating access for non-members or others with restricted or limited access to secured websites and certain information contained therein, comprising:
a memory device; and
a processor disposed in communication with the memory device, the processor configured to:
receive instructions to send an invitation to join the website to a non-member or to view the member's information therein;
generate a link allowing access; and
transmit the link to grant permission to access the website and to view the member's information therein.

2. The system of claim 1 wherein the generation of a link includes providing a download of software to permit access to the secured site and to the member's information therein.

3. The system of claim 1, wherein the transmitting is done by an email, instant message, text message or blog message.

4. The system of claim 1 wherein the generation of the link is done by an Aggregator Site.

5. The system of claim 4, wherein the Aggregator Site is independent of the secured site.

6. The system of claim 1, wherein the secured site is a members' only networking website or otherwise restricts unfettered access by non-members.

7. The system of claim 1, wherein an aggregator site is in communication with at least one of the following: secured site, affiliated email or text, unaffiliated email or text, or internet service provider.

8. The system of claim 1, wherein the processor is further configured to allow recipients of the invitation to access the secured site at other times without further login procedures.

9. A system for generating access for non-members or others with restricted or limited access to secured websites and certain information contained therein, comprising:
a memory device; and
a processor disposed in communication with the memory device, the processor configured to:
generating a message automatically to a recipient that may or may not be a member of a website to allow access to another member's information or websites;
receive instructions to send an invitation to join the website or to view the member's information therein;
generate a link allowing access; and
transmit the link to grant permission to access the website and to view the member's information therein.

10. A system for filtering information from one or more networking websites to a single amalgamated site, comprising:
a memory device; and
a processor disposed in communication with the memory device, the processor configured to:
receive instructions from a user to select filtered information from one or more networking websites, blogs or other internet based sites; and
transmit the filtered information to an amalgamated website that can be accessed by the user, said user given permission to grant access the amalgamated website.

11. The system of claim 10 further includes generating a personalized amalgamated website for the user to contain the filtered information.

12. The system of claim 10, wherein the transmitting is done by an email, instant message, text message or blog message.

13. The system of claim 10 further includes sending an invitation to a Recipient to view the Amalgamated website.

14. The system of claim 10 wherein the Amalgamated website is independent of the networking sites secured site.

15. The system of claim 10, wherein the Amalgamated website is a secured site or members' only networking website or otherwise restricts unfettered access by non-members.

16. The system of claim 10, wherein an Amalgamated website is in communication with at least one of the following: secured site, affiliated email or text, unaffiliated email or text, or internet service provider.

17. The system of claim 10, wherein the processor is further configured to allow recipients of the invitation to access the Amalgamated website at other times without further login procedures.
